(19) United States
(12) Patent Application Publication
(10) Pub. No.: US 2016/0050644 A1
(43) Pub. Date: Feb. 18, 2016

(54) METHODS AND APPARATUS FOR QUICK BURST TUNE AWAY IN MULTI-SIM DEVICES

(71) Applicant: QUALCOMM Incorporated, San Diego, CA (US)

(72) Inventors: Raghavendra Shyam Anand, Chickballapur (IN); Parthasarathy Krishnamoorthy, Hyderabad (IN); Rashid Ahmed Akbar Attar, San Diego, CA (US); Jun Hu, San Diego, CA (US); Anand Rajurkar, Hyderabad (IN)

(21) Appl. No.: 14/459,190

(22) Filed: Aug. 13, 2014

(51) Int. Cl. H04W 68/02; H04W 88/06

(52) U.S. Cl. CPC H04W 68/02; H04W 88/06

(57) ABSTRACT

Methods and apparatus for wireless communication are provided. In one aspect, an apparatus for wireless communication comprises a processor configured to determine a time when the plurality of page bursts for the first radio access technology (RAT) will be received. The processor further configured to allocate a portion of time between page bursts for use by a second RAT.

### BACKGROUND

1. Field

Certain aspects of the present disclosure generally relate to wireless communication systems, and more particularly, to methods and apparatus for implementing a quick burst tune away in multi-subscriber identity module (SIM) devices.

2. Background

In many telecommunication systems, communications networks are used to exchange messages among several interacting spatially-separated devices. In some implementations, a UE may be configured to communicate utilizing more than one communication protocol utilizing more than one radio access technology (RAT). Such devices may be known as Multi-SIM devices. When managing the UE's access to more than one RAT, it may become necessary to tune the transmit chain and the receive chain of the UE's transceiver for transmitting and/or receiving, respectively, at frequencies associated with either a first RAT or with a second RAT. The existing monolithic tune away mechanisms are highly time consuming thereby affecting the overall device performance to a great extent, especially when the Multi-SIM device has single transceiver chain. Accordingly, there is a need for methods and apparatuses for an efficient quick burst tune away in Multi-SIM devices.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an apparatus for wireless communication. The apparatus includes a processor configured to determine a time when the plurality of page bursts for the first radio access technology (RAT) will be received. The processor is further configured to allocate a portion of time between page bursts for use by a second RAT.

Another aspect of the disclosure provides a method for sharing a radio frequency chain during a process for receiving a plurality of page bursts for a first radio access technology (RAT). The method includes determining a time when the plurality of page bursts for the first radio access technology will be received. The method further includes allocating a portion of time between page bursts for use by a second RAT.

Another aspect of the disclosure provides an apparatus for wireless communication. The apparatus includes means for determining a time when the plurality of page bursts for the first radio access technology will be received. The apparatus further includes means for allocating a portion of time between page bursts for use by a second RAT.

Another aspect of the disclosure provides a non-transitory computer-readable medium comprising code that, when executed, causes a processor to determine a time when the plurality of page bursts for the first radio access technology (RAT) will be received. The code, when executed, further causes the processor to allocate a portion of time between page bursts for use by a second RAT.

### BRIEF DESCRIPTION OF THE DRAWINGS

FIG. 1 illustrates an example of a wireless communication system in which aspects of the present disclosure may be employed, according to an implementation.

FIG. 2 illustrates various components that may be utilized in a wireless Multi-SIM device that may be employed within the wireless communication system of FIG. 1, according to an implementation.

FIG. 3 is an exemplary time sequence diagram showing a quick tune away (QTA) procedure in a wireless Multi-SIM device that may be employed within the wireless communications system of FIG. 1, according to an implementation.

FIG. 4 is an exemplary time sequence diagram showing a quick burst tune away (QBTA) procedure in a wireless Multi-SIM device that may be employed within the wireless communications system of FIG. 1, according to an implementation.

FIG. 5 is a flow chart of an exemplary method for wireless communication, according to an implementation.

FIG. 6 is a functional block diagram of a wireless Multi-SIM device that can be employed to perform the method of FIG. 4 in the wireless communication system of FIG. 1, according to an implementation.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

In some implementations, a wireless local area network (WLAN) includes various devices which are the components that access the wireless network. For example, there can be two types of devices: access points (“APs”) and clients (also referred to as stations, or “STAs”). In general, an AP can serve as a hub or base station for the WLAN and a STA serves as a user of the WLAN. For example, a STA can be a laptop computer, a personal digital assistant (PDA), a mobile phone, a wearable computing device (e.g., a watch), an appliance, a sensor, a vending machine, etc. In some implementations a STA can also be used as an AP.

An access point (“AP”) can also include, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” can also include, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal can include a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device or wireless device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

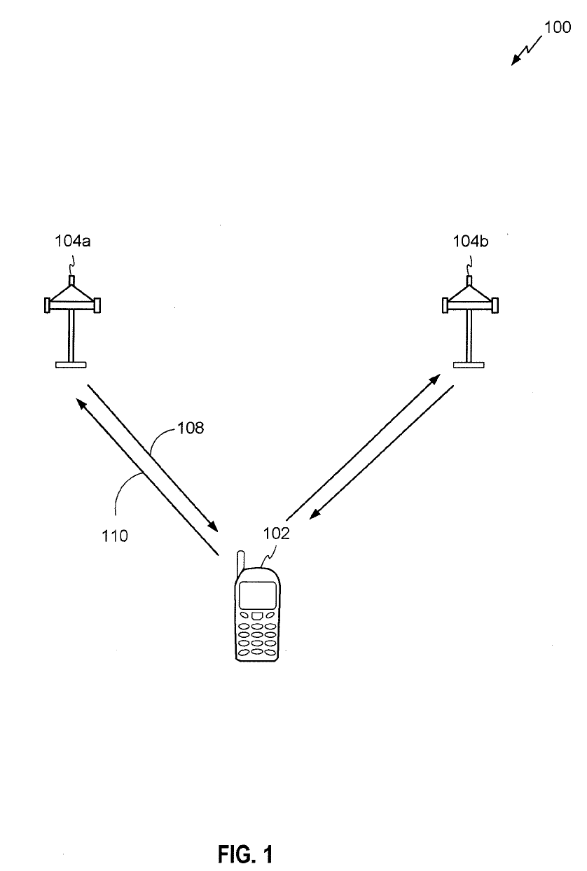

FIG. 1 illustrates an example of a wireless communication system 100 in which aspects of the present disclosure can be employed in accordance with an implementation. The wireless communication system 100 can include a first AP 104a and a second AP 104b. Each of the APs 104a and 104b may communicate with an STA 102, which may be a Multi-SIM device, e.g., may be capable of communicating utilizing more than one radio access technology (RAT). For example, the first AP 104a may be configured as a base station associated with a first RAT while the second AP 104b may be configured as a base station associated with a second RAT. Although only two APs 104a and 104b are shown, the present application is not so limited and any number of APs serving any number of RATs may be present.

A variety of processes and methods can be used for transmissions in the wireless communication system 100 between the APs 104a and 104b and the STA 102. For example, signals can be sent and received in accordance with OFDM/OFDMA techniques. If this is the case, the wireless communication system 100 can be referred to as an OFDM/OFDMA system. Alternatively, signals can be sent and received in accordance with code division multiple access (CDMA) techniques. If this is the case, the wireless communication system 100 can be referred to as a CDMA system.

A communication link that facilitates transmission from an AP to the STA 102 can be referred to as a downlink (DL) 108, and a communication link that facilitates transmission from the STA 102 to an AP can be referred to as an uplink (UL) 110. Alternatively, a downlink 108 can be referred to as a forward link or a forward channel, and an uplink 110 can be referred to as a reverse link or a reverse channel.

The APs 104a and 104b may act as base stations and provide wireless communication coverage in respective basic service areas (BSAs) (not shown). An AP along with any STAs being served by the AP and/or that use the AP for communication can be referred to as a basic service set (BSS).

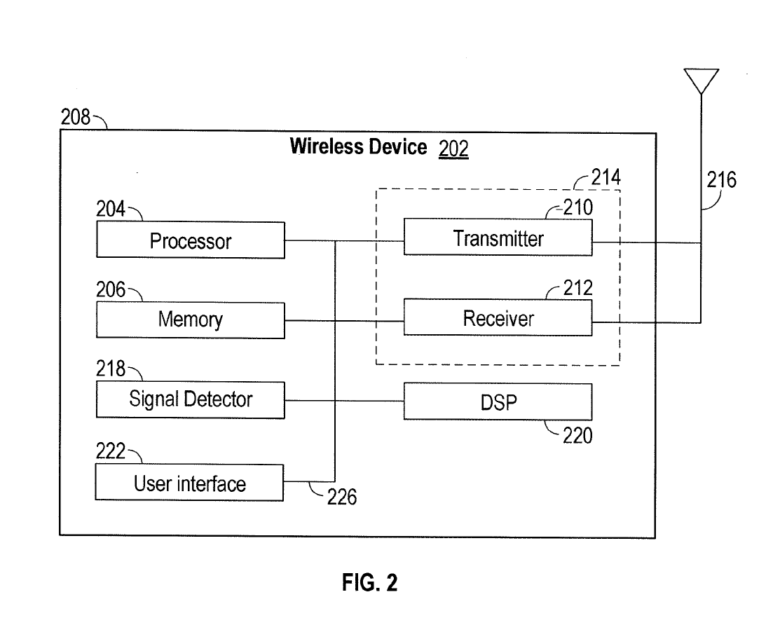

FIG. 2 illustrates various components that can be utilized in a wireless device 202 that can be employed within the wireless communication system 100 in accordance with an implementation. The wireless device 202 is an example of a wireless device that can be configured to implement the various methods described herein. For example, the wireless device 202 can comprise one of the APs 104a and 104b or the STA 102.

The wireless device 202 can include a processor 204 which controls operation of the wireless device 202. The processor 204 can also be referred to as a central processing unit (CPU). Memory 206, which can include both read-only memory (ROM) and random access memory (RAM), can provide instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and/or a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas.

The transmitter 210 can be configured to wirelessly transmit packets having different packet types or functions. For example, the transmitter 210 can be configured to transmit packets of different types generated by the processor 204. When the wireless device 202 is implemented or used as an AP 104 or STA 102, the processor 204 can be configured to process packets of a plurality of different packet types. For example, the processor 204 can be configured to determine the type of packet and to process the packet and/or fields of the packet accordingly.

The receiver 212 can be configured to wirelessly receive packets having different packet types. In some aspects, the receiver 212 can be configured to detect a type of a packet used and to process the packet accordingly.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a packet for transmission. In some aspects, the packet can comprise a physical layer data unit (PPDU).

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user. The wireless device can further comprise a battery (not shown) to power the wireless device.

The various components of the wireless device 202 can be coupled together by a bus system 226. The bus system 226 can include a data bus, for example, as well as a power bus, a control signal bus, and a status signal bus in addition to the data bus. The components of the wireless device 202 can be coupled together or accept or provide inputs to each other using some other mechanism.

Although a number of separate components are illustrated in FIG. 2, one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

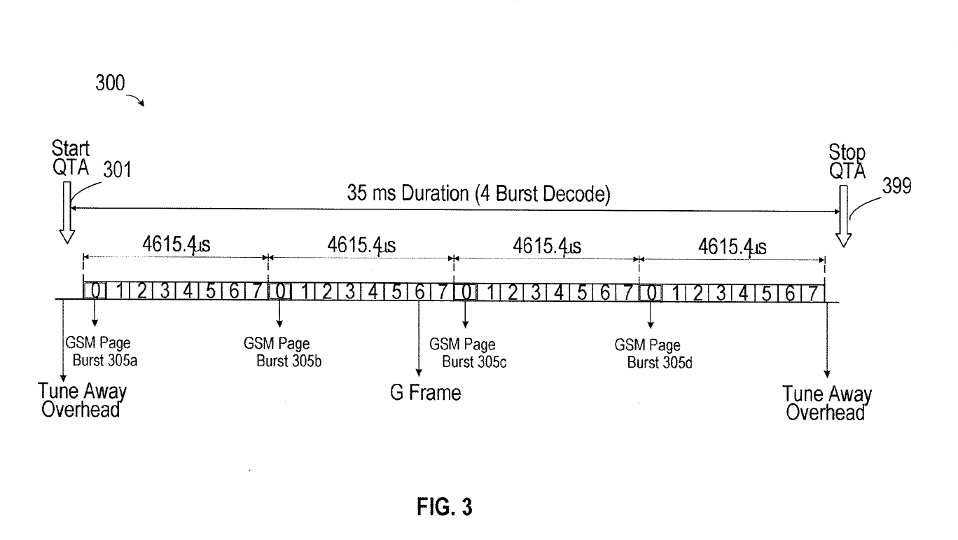

In conventional multi-SIM devices having a single radio frequency (RF) chip comprising a single transceiver chain, when one RAT is participating in transmitting data (i.e., in data traffic) each other supported RAT may perform a periodical tune away in order to monitor an associated page according to discontinuous reception cycles (i.e., DRx cycles) for each RAT. For example, in a Multi-SIM device which has global system for mobile communications (GSM) as one of its subscriptions, a GSM page block consists of 4 page bursts interleaved across 4 time division multiple access (TDMA) frames, each TDMA frame comprising 8 slots, as shown in FIG. 3 (more fully described below). In some implementations, GSM would be given a RF chain for the entire duration until it completes the page decode. Hence, other RATs will not be able to access the RF chain in-between the GSM page bursts. Having the GSM RAT hold the RF chain for the entire 4 TDMA frames is an inefficient approach for the following reasons. The GSM page burst receptions will be completed at the end of the first slot (e.g., slot 0) in a TDMA frame. Thus, there is no need to listen to the remaining slots of the frame for GSM page reception. Such inefficiencies in a monolithic quick tune away (QTA) approach may thereby affect the other RATs' performance especially when the Multi-SIM device has single transceiver chain. For example, data throughput may be degraded because the GSM tune away is frequent due to shorter DRx cycles and high tune away duration. Additionally, chances of resource constraint may be high because GSM tune away duration is high and thereby overall device performance may be degraded, especially in transaction switching and transport service (e.g., TSTS) device and/or a quad SIM quad standby (e.g., QSQS) devices. Moreover, monolithic tune away may result in missing transmit power control commands sent by a base station in the case of 3rd Generation Partnership Project (3GPP) RATs. With an increased number of Multi-SIM mobiles, base station capacity may be reduced because of excess interference caused by rogue mobiles (by deviating away from power control protocol). Accordingly, the present application offers a solution to the above-stated problems.

FIG. 3 is an exemplary time sequence diagram 300 showing a GSM quick tune away (QTA) procedure in a wireless Multi-SIM device that may be employed within the wireless communications system of FIG. 1, according to an implementation. As shown, the QTA begins at time 301 and after a duration for tune away overhead, each GSM page burst reception 305 occurs during slot 0 of each of the four TDMA frames. Each TDMA frame may have a duration of 4615.4 μs and the total time for the QTA procedure may last 35 ms. As described above, the GSM subscription holds the RF chain for the entire QTA which does not allow other RATs to access RF chain during the QTA.

In the present application, since page reception for the GSM RAT requires the use of

RF chain only during the GSM page burst reception, the GSM tune away may be carried out per page burst such that the GSM subscription can share the RF chain with other RATs present in the device in-between two page bursts. Thus, the RF chain can be handed over to other RATs to allow another RAT to perform its desired activity. Meanwhile, GSM firmware can start processing the GSM page burst even when the RF is tuned to other RAT.

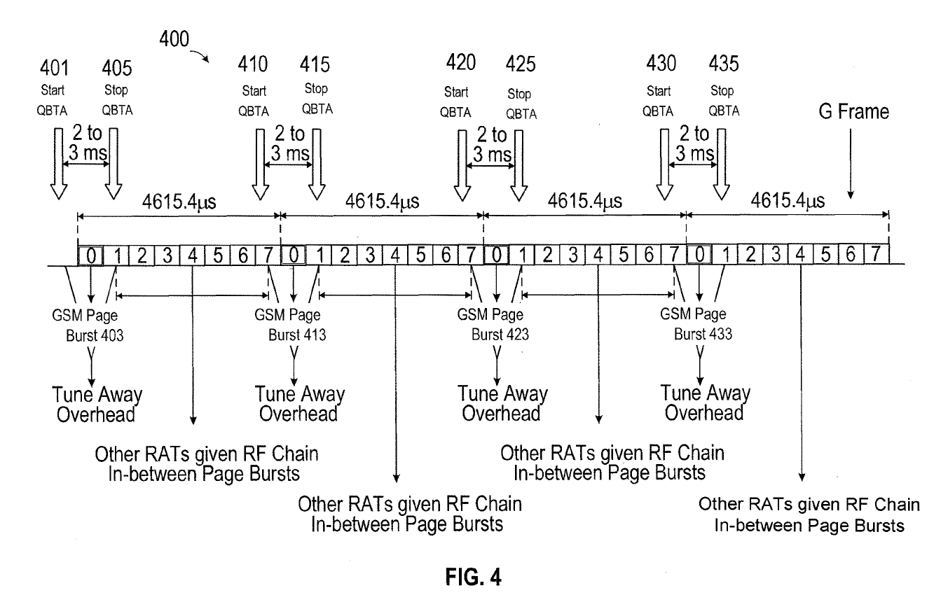

FIG. 4 is an exemplary time sequence diagram 400 showing a GSM quick burst tune away (QBTA) procedure in a wireless Multi-SIM device that may be employed within the wireless communications system of FIG. 1, according to an implementation. The exemplary diagram 400 may correspond to a CDMA+GSM dual SIM dual standby (DSDS) wireless device. However, the present application is not so limited and the implementations described herein may additionally or alternatively apply to any other Multi-SIM wireless device. Exemplary diagram 400 shows 8 GSM time TDMA slots (labeled 0-7) in each of 4 TDMA frames. In some implementations, the GSM TDMA slots may correspond to a receive (Rx) transceiver chain, which may be tuned away for page reading purposes of a second RAT, for example.

As shown in FIG. 4, a QBTA begins at time 401 and after a time for tune away overhead, a GSM page burst 0 occurs at time 403 during the slot “0.” After some additional tune away overhead the QBTA ends at time 405. In between the time 405 and the start of the next QBTA at time 410, the GSM network may share the RF chain with other RATs of the Multi-SIM wireless device. In some embodiments, the presence of a high resolution tuning apparatus in the wireless Multi-SIM device (e.g., wireless device 202) may enable GSM layer 1 (L1) to tune in a short time (e.g., 1 ms) before the actual GSM page burst arrival and tune back after a short time (e.g., 1 ms) the GSM page decode is done such that the time duration for a QBTA tune away becomes very short (e.g., in the order of 2 to 3 ms). A handoff operation to a second RAT (e.g., GSM TDMA) may occur during a subsequent slot (e.g., slots 1-7 between times 405 and 410). Such a QBTA operation may occur during the other GSM page bursts (e.g., GSM page bursts 1-3 at times 413, 423, and 433).

In some embodiments, depending on a gap between two consecutive GSM burst receptions (e.g., the time between time 405 and 410), the Multi-SIM wireless device may dynamically schedule the per burst QBTA or may combine “n” number of bursts into one bigger QBTA gap. For example, in one embodiment, the second RAT may require a time greater than the time between times 405 and 410 to send a transmission. In this embodiment, the Multi-SIM wireless device (e.g., wireless device 202) may combine the GSM page bursts 403, 413 such that the time gap between the GSM page bursts 413 and 423 becomes approximately twice as long as the time between GSM page bursts 413 and 423 shown in FIG. 4. In other embodiments, based on the length of the QBTA gap, the Multi-SIM wireless device may dynamically adjust the other RAT's behavior with the aim of achieving better power savings, better performance, etc. For example, in a high data rate (HDR) RAT the Multi-SIM wireless device may either stop reverse medium access control (RMAC) or perform discontinuous transmission (DTx) operations. In a similar way, other RATs also dynamically adjust their behavior to achieve better power savings, better performance, etc.

In some embodiments, along with a page burst reception the Multi-SIM wireless device may club power measurement in the same QBTA gap or the power measurement may be dynamically distributed as well across the TDMA frame in such a way that impact to other RAT's performance is minimal.

The QBTA structure provides a mechanism for multiple short tune aways to perform GSM page reception and it is efficient for the following reasons. For example, the QBTA tune away duration is short compared to the QTA such that the tune away from a data RAT is minimized to a great extent, thereby improving the data throughput. In some embodiments with full QBTA, DSDS throughputs may be indistinguishable from single SIM throughput, both on UL and DL. Additionally with QBTA, resource constraint or collision may be avoided to a great extent as tune away duration is shorter compared to QTA and other RATs may be able to access the RF chain during most of the GSM page block time thereby the overall device performance improved. Further, the short tune away duration in a QBTA structure may minimize occurrences of the wireless device missing transmit power control commands sent by a base station. Thereby, the AT is not transmitting at too high a power post QBTA gap than what is desired by the base station and hence, unnecessary interference may be avoided and no impact to base station capacity occurs.

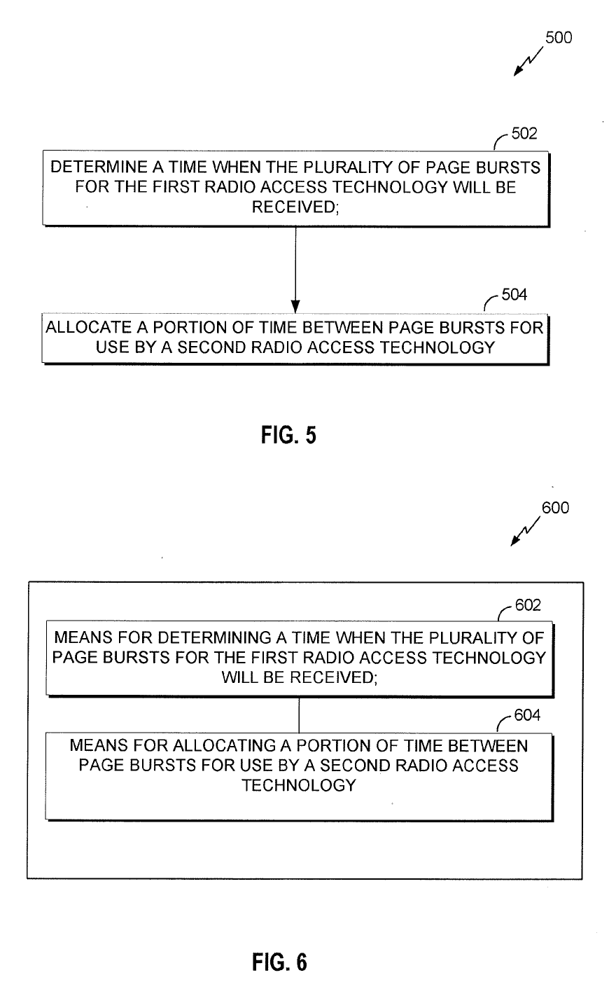

FIG. 5 is a flow chart of an exemplary method 500 for wireless communication, according to an implementation. Although the method 500 in FIG. 5 is illustrated in a particular order, in some implementations the blocks herein may be performed in a different order, or omitted, and additional blocks can be added. A person of ordinary skill in the art will appreciate that the process of the illustrated implementation may be implemented in any wireless device that can be configured to process and transmit a generated message.

Operation block 502 includes determining a time when the plurality of page bursts for the first radio access technology will be received. For example, as previously described, the processor 204 of the wireless device 202 of FIG. 2 may determine a time when the plurality of page bursts for the first radio access technology will be received, such as GSM page burst 0-3 of FIG. 4.

Operation block 504 includes allocating a portion of time between page bursts for use by a second RAT. For example, as previously described, the processor 204 of the wireless device 202 of FIG. 2 may allocate a portion of time between page bursts for use by a second RAT, such as the time between time 405 and 410 depicted in FIG. 4. Operation block 506 includes receiving the plurality of page bursts on the first RAT. For example, as previously described, the receiver 212 of the wireless device 202 of FIG. 2 may receive the plurality of page bursts on the first RAT.

FIG. 6 is a functional block diagram of an apparatus 600 that can be employed to perform a method 500 of FIG. 5 in the wireless communication system of FIG. 1. Those skilled in the art will appreciate that the apparatus 600 may have more components than the simplified block diagrams shown in FIG. 6. FIG. 6 includes only those components useful for describing some prominent features of implementations within the scope of the claims.

The wireless device 600 includes means 602 for determining a time when the plurality of page bursts for the first radio access technology will be received. In some implementations, means 602 may be configured to perform one or more of the functions described above with respect to operation block 502 of FIG. 5. In various implementations, means 602 may be implemented by the processor 204 or DSP 220 of the wireless device 202 of FIG. 2. The wireless device 600 includes means 604 for allocating a portion of time between page bursts for use by a second RAT. In some implementations, means 604 may be configured to perform one or more of the functions described above with respect to operation block 504 of FIG. 5. In various implementations, means 604 may be implemented by the processor 204 or DSP 220 of the wireless device 202 of FIG. 2. The wireless device 600 includes means 606 for receiving the plurality of page bursts on the first RAT. In some implementations, means 606 may be configured to perform one or more of the functions described above with respect to operation block 506 of FIG. 5. In various implementations, means 604 may be implemented by the receiver 212 of the wireless device 202 of FIG. 2.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In some aspects, wireless signals may be transmitted utilizing various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

1. An apparatus for wireless communication, comprising:
a processor configured to:
determine a time when a plurality of page bursts of a paging message for a first radio access technology (RAT) will be received, the plurality of page bursts comprising a first page burst and a second page burst; and
allocate a portion of time between the first page burst and the second page burst for use by a second RAT; and
a receiver configured to receive the plurality of page bursts on the first RAT.

2. The apparatus of claim 1, wherein the processor is further configured to tune the receiver to the first RAT a first predetermined time before the determined time when the first page burst of the plurality of page bursts for the first RAT will be received.

3. The apparatus of claim 2, wherein the first predetermined time comprises approximately 1-2 milliseconds.

4. The apparatus of claim 2, wherein the processor is further configured to tune the receiver to the second RAT a second predetermined time after the determined time when the first page burst for the first RAT will be received.

5. The apparatus of claim 4, wherein the second predetermined time comprises approximately 1-2 milliseconds.

6. The apparatus of claim 1, wherein the processor is further configured to allocate a portion of time between the first page burst and the second page burst for power measurement.

7. The apparatus of claim 1, wherein the processor is further configured to selectively allocate a second portion of time between the first page burst and the second page burst for use by the second RAT based on a transmission time of a message transmitted on the second RAT.

8. The apparatus of claim 1, wherein the receiver is configured to receive a message indicating a dynamic schedule for receiving the plurality of page bursts.

9. The apparatus of claim 1, further comprising a transmitter configured to selectively transmit a message on the second RAT based on the allocated portion of time.

10. The apparatus of claim 9, wherein the transmitter is further configured to transmit a message on the second RAT when the allocated portion of time satisfies a threshold.

11. The apparatus of claim 1, wherein the first radio access technology is different from the second radio access technology.

12. A method for sharing a radio frequency chain during a process for receiving a plurality of page bursts of a paging message for a first radio access technology (RAT), comprising:
determining a time when a first page burst and a second page burst of the plurality of page bursts for the first radio access technology will be received;
allocating a portion of time between the first page burst and the second page burst for use by a second RAT; and
receiving the plurality of page bursts on the first RAT.

13. The method of claim 12, further comprising tuning to the first RAT a first predetermined time before the determined time when the first page burst of the plurality of page bursts for the first RAT will be received.

14. The method of claim 13, wherein the first predetermined time comprises approximately 1-2 milliseconds.

15. The method of claim 13, further comprising tuning to the second RAT a second predetermined time after the determined time when the first page burst for the first RAT will be received.

16. The method of claim 15, wherein the second predetermined time comprises approximately 1-2 milliseconds.

17. The method of claim 12, further comprising allocating a portion of time between the first page burst and the second page burst for power measurement.

18. The method of claim 12, further comprising allocating a second portion of time between the first page burst and the second page burst for use by the second RAT based on a transmission time of a message transmitted on the second RAT.

19. The method of claim 12, wherein determining a time comprises receiving a message indicating a dynamic schedule for receiving the plurality of page bursts.

20. The method of claim 12, further comprising selectively transmitting a message on the second RAT based on the allocated portion of time.

21. The method of claim 20, wherein selectively transmitting a message comprises transmitting the message on the second RAT when the allocated portion of time satisfies a threshold.

22. The method of claim 12, wherein the first radio access technology is different from the second radio access technology.

23. An apparatus for wireless communication, comprising:
means for determining a time when the plurality of page bursts of a paging message for a first radio access technology (RAT) will be received, the plurality of page bursts comprising a first page burst and a second page burst;
means for allocating a portion of time between the first page burst and the second page burst for use by a second RAT; and
means for receiving the plurality of page bursts on the first RAT.

24. The apparatus of claim 23, further comprising means for tuning to the first RAT a first predetermined time before the determined time when the first page burst of the plurality of page bursts for the first RAT will be received.

25. The apparatus of claim 24, further comprising means for tuning to the second RAT a second predetermined time after the determined time when the first page burst for the first RAT will be received.

26. The apparatus of claim 23, further comprising means for selectively transmitting a message on the second RAT based on the allocated portion of time.

27. A non-transitory computer-readable medium comprising code that, when executed, causes a processor to:
determine a time when the plurality of page bursts of a paging message for the first radio access technology (RAT) will be received, the plurality comprising a first page burst and a second page burst;
allocate a portion of time between the first page burst and the second page burst for use by a second RAT; and
receive the plurality of page bursts on the first RAT.

28. The non-transitory computer-readable medium of claim 27, wherein the code, when executed, causes the processor to tune to the first RAT a first predetermined time before the determined time when the first page burst of the plurality of page bursts for the first RAT will be received.

29. The non-transitory computer-readable medium of claim 28, wherein the code, when executed, causes the processor to tune the receiver to the second RAT a second predetermined time after the determined time when the first page burst for the first RAT will be received.

30. The non-transitory computer-readable medium of claim 27, wherein the code, when executed, causes the processor to selectively transmit a message on the second RAT based on the allocated portion of time.
